(19) United States
(12) Patent Application Publication
(10) Pub. No.: US 2026/0316557 A1
(43) Pub. Date: Oct. 15, 2026

(54) DISCONNECT DEVICE

(71) Applicant: HYUNDAI WIA Corporation, Changwon-si (KR)

(72) Inventor: Ji Eun Lee, Uiwang-si (KR)

(73) Assignee: HYUNDAI WIA Corporation, Changwon-si, GN (KR)

(21) Appl. No.: 19/452,188

(22) Filed: Jan. 16, 2026

(30) Foreign Application Priority Data
Jan. 16, 2025 (KR) 10-2025-0006912
Jan. 2, 2026 (KR) 10-2026-0000215

(51) Int. Cl. B60K 23/08; F16D 23/08; F16D 23/12

(52) U.S. Cl. CPC B60K 23/08; F16D 23/12; F16D 23/08; F16D 2023/123

(57) ABSTRACT

The present disclosure relates to a disconnect device comprising: a first shaft capable of rotating; a second shaft capable of rotating coaxially with the first shaft; a first clutch disk coupled to the first shaft; a second clutch disk coupled to the second shaft; a ball ramp mechanism configured to engage and disengage the first clutch disk and the second clutch disk; and a stopper pin configured to stop the first shaft when the first clutch disk and the second clutch disk are disengaged from each other. Accordingly, rotation of the first shaft 100, which is deactivated when switching from four-wheel drive mode to two-wheel drive mode, is immediately stopped, thereby improving fuel efficiency and power efficiency.

### CROSS REFERENCE TO RELATED APPLICATION

The present application claims priority to Korean Patent Application No. 10-2025-0006912, filed Jan. 16, 2025 and Korean Patent Application No. 10-2026-0000215, filed Jan. 2, 2026, the entire contents of which is incorporated herein for all purposes by this reference.

### BACKGROUND OF THE INVENTION

### Field of the Invention

The present disclosure relates to a disconnect device, more particularly, to a disconnect device for implementing a two-wheel/four-wheel drive conversion system for a vehicle.

### Description of the Conventional Art

Generally, automobiles are classified into two-wheel drive systems that drive only the front or rear wheels, and four-wheel drive systems that drive both the front and rear wheels. The four-wheel drive systems offer higher driving stability than two-wheel drive systems and are more suitable for rough terrain driving, such as in mountainous areas. The four-wheel drive systems are further divided into permanent four-wheel drive systems and two-wheel/four-wheel switchable drive systems. The two-wheel/four-wheel switchable drive systems require a disconnect device to stop rotation of non-functional parts during a two-wheel drive mode, thereby improving fuel efficiency and power efficiency.

FIG. 1 is a cross-sectional view illustrating a conventional disconnect device in a four-wheel drive state, and

FIG. 2 is a cross-sectional view illustrating the disconnect device of FIG. 1 in a two-wheel drive state.

Referring to FIGS. 1 and 2, a conventional disconnect device comprises a first shaft 10 capable of rotating, a second shaft 20 capable of rotating coaxially with the first shaft 10, a first clutch disk 30 coupled to the first shaft 10, a second clutch disk 40 coupled to the second shaft 20, and a ball ramp mechanism 50 configured to engage and disengage the first clutch disk 30 and the second clutch disk 40.

In the conventional disconnect device having this configuration, as illustrated in FIG. 1, a ball ramp plate 53 of the ball ramp mechanism 50 presses against a clutch disk pack 30 and 40 including the first clutch disk 30 and the second clutch disk 40, thereby causing the first clutch disk 30 and the second clutch disk 40 to engage. When the first shaft 10 and the second shaft 20 are engaged, the vehicle may be driven in a four-wheel drive mode.

On the other hand, as illustrated in FIG. 2, when the ball ramp plate 53 is disengaged from the clutch disk pack 30 and 40, the first clutch disk 30 and the second clutch disk 40 are disengaged from each other, thereby disengaging the first shaft 10 and the second shaft 20, and the vehicle may be driven in a two-wheel drive mode.

However, in such conventional disconnect devices, fuel efficiency or power efficiency may be reduced because the first shaft 10, which should be deactivated when switching from the four-wheel drive mode to the two-wheel drive mode, does not stop immediately but instead decelerates due to drag torque and inertial force before coming to a stop.

### SUMMARY OF THE INVENTION

Accordingly, the present disclosure aims to provide a disconnect device capable of immediately stopping the portion that should be deactivated when switching from a four-wheel drive system to a two-wheel drive system.

To achieve the aforementioned object, a disconnect device of the present disclosure comprises: a first shaft capable of rotating; a second shaft capable of rotating coaxially with the first shaft; a first clutch disk coupled to the first shaft; a second clutch disk coupled to the second shaft; a ball ramp mechanism configured to engage and disengage the first clutch disk and the second clutch disk; and a stopper pin configured to stop the first shaft when the first clutch disk and the second clutch disk are disengaged from each other.

The stopper pin may be provided to be operated by the ball ramp mechanism.

The ball ramp mechanism may include a ball ramp gear capable of rotating coaxially with the first shaft and the second shaft. The ball ramp gear is configured to engage the first clutch disk and the second clutch disk when rotated in a first direction, and to disengage the first clutch disk from the second clutch disk when rotated in a second direction opposite to the first direction. The ball ramp gear may have an inclined surface configured to move a stopper pin in a direction to stop the first shaft when the ball ramp gear is rotated in the second direction.

The first shaft is configured to receive the first clutch disk and includes a drum coupled to an outer circumferential portion of the first clutch disk. The ball ramp mechanism further includes a case arranged between the drum and the ball ramp gear, the case being configured to support the ball ramp gear and including a slot configured to reciprocally receive the stopper pin in the axial direction transverse to the drum and the ball ramp gear, and the ball ramp gear having a slot-facing surface with respect to the slot. An inclined surface for moving the stopper pin may be formed on the ball ramp gear, the inclined surface having a shape such that distance to the drum decreases in a first direction from the slot-facing surface. The drum includes a plurality of grooves defined (e.g., engraved) in an outer circumferential surface of the drum, extending in the axial direction of the drum, and arranged along the circumferential direction of the drum. The stopper pin may have a first end portion configured to be supportable on the inclined surface and a second end portion configured to be insertable into one of a plurality of grooves.

Alternatively, the drum may include an annular end face configured to extend along the circumferential direction of the drum and to face the slot, and the stopper pin may include a first end portion configured to be supportable on the inclined surface and a second end portion configured to be contactable with the end face.

A non-metallic member may be disposed on at least one of the end face and the second end portion.

The non-metallic member may be disposed on the second end portion.

The non-metallic member may be formed from a material having a friction coefficient greater than a predetermined friction coefficient.

An elastic member may be provided to pressurize the stopper pin toward the inclined surface.

The slot may have: a first opening on the ball ramp gear side; a second opening on the drum side, the second opening having an inner diameter less than that of the first opening; a first diameter portion extending from the first opening toward the second opening and having the same inner diameter as the first opening; a second diameter portion extending from the second opening toward the first opening, communicating with the first diameter portion, and having the same inner diameter as the second opening; and a step surface formed by a difference in inner diameter between the first and second diameter portions. The stopper pin may include: a first end portion projecting outward from the first opening; a second end portion projecting outward from the second opening; and a step portion projecting radially outward between the first end portion and the second end portion. The elastic member may be provided as a compression coil spring compressible by the step surface and the step portion.

The slot may have: a first opening on a ball ramp gear side; a second opening on the drum side, the second opening having an inner diameter less than that of the first opening; a first diameter portion extending from the first opening toward the second opening and having the same inner diameter as the first opening; a second diameter portion extending from the second opening toward the first opening and having the same inner diameter as the second opening; a third diameter portion communicating with the first diameter portion and the second diameter portion and having an inner diameter greater than that of the second diameter portion and less than that of the first diameter portion; a first step surface formed by a difference in inner diameter between the first diameter portion and the third diameter portion; and a second step surface formed by a difference in inner diameter between the second diameter portion and the third diameter portion. The stopper pin may include a first end portion configured to project from the first opening, a second end portion formed separately from the first end portion, a first step portion projecting radially outward from the first end portion, and a second step portion projecting radially outward from the second end portion. The second step portion may have a shape configured to be supportable on the first step surface. The elastic members may be provided as a first compression coil spring compressible by the first step portion and the second step portion, and a second compression coil spring compressible by the second step surface and the second step portion.

### BRIEF DESCRIPTION OF THE DRAWINGS

FIG. 1 is a cross-sectional view illustrating a conventional disconnect device in a four-wheel-drive state.

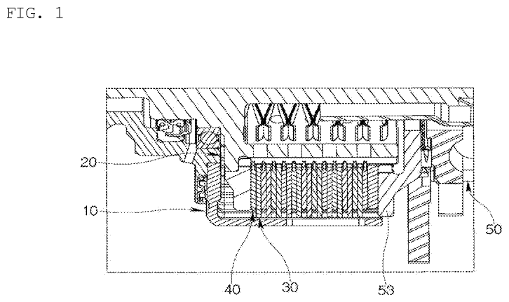

FIG. 2 is a cross-sectional view illustrating the disconnect device of FIG. 1 in a two-wheel drive state.

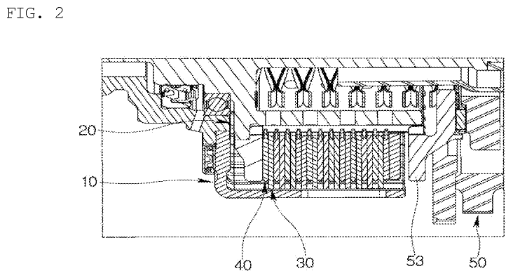

FIG. 3 is an exploded perspective view illustrating a disconnect device according to an embodiment of the present disclosure.

FIG. 4 is a perspective view illustrating a ball ramp gear of FIG. 3.

FIG. 5 is a cross-sectional view illustrating a disconnect device of FIG. 3 in a four-wheel drive state.

FIG. 6 is a cross-sectional view illustrating a disconnect device of FIG. 3 in a two-wheel drive state.

FIG. 7 is a cross-sectional view illustrating a disconnect device according to another embodiment of the . present disclosure.

FIG. 8 is a perspective view illustrating a disconnect device according to another embodiment of the present disclosure.

### DETAILED DESCRIPTION OF THE PREFERRED EMBODIMENT

Hereinafter, exemplary embodiments of a disconnect device according to the present disclosure will be described in detail with reference to the accompanying drawings.

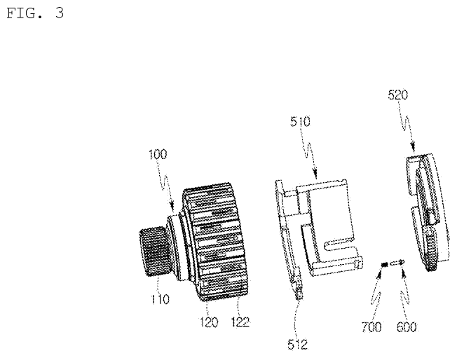

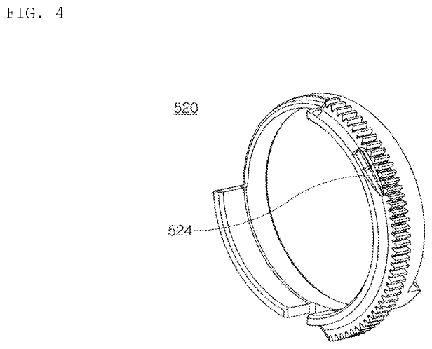

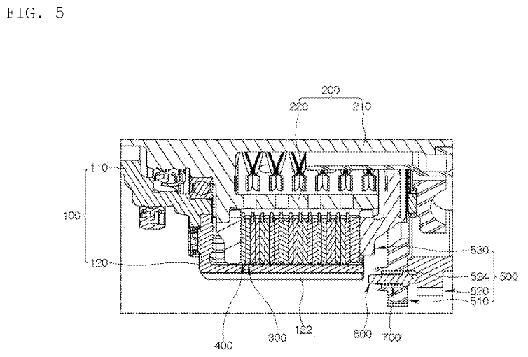

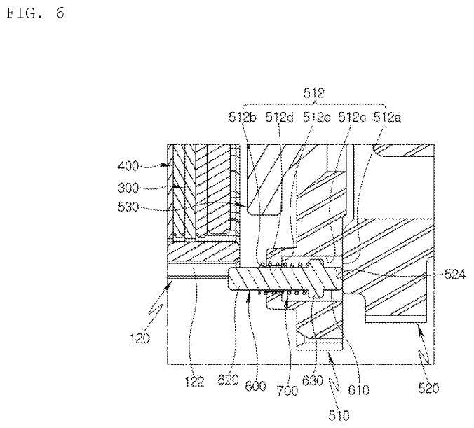

FIG. 3 is an exploded perspective view illustrating a disconnect device according to an embodiment of the present disclosure, FIG. 4 is a perspective view illustrating a ball ramp gear of FIG. 3, FIG. 5 is a cross-sectional view illustrating the disconnect device of FIG. 3 in a four-wheel drive state, and FIG. 6 is a cross-sectional view illustrating the disconnect device of FIG. 3 in a two-wheel drive state.

As illustrated in these drawings, a disconnect device according to an embodiment of the present disclosure comprises: a first shaft 100 capable of rotating; a second shaft 200 capable of rotating coaxially with the first shaft 100; a first clutch disk 300 coupled to the first shaft 100; a second clutch disk 400 coupled to the second shaft 200; a ball ramp mechanism 500 configured to engage and disengage the first clutch disk 300 and the second clutch disk 400; and a stopper pin 600 configured to stop the first shaft 100 when the first clutch disk 300 and the second clutch disk 400 are disengaged from each other.

The first shaft 100 may have a first shaft portion 110 connected to one side gear of a differential assembly, and an annular first drum 120 extending radially outward from the first shaft portion 110, for example.

The second shaft 200 may have a second drum 220 received in the first drum 120 and a second shaft portion 210 extending axially from the second drum 220 and connected to a wheel, such as a vehicle wheel.

The first clutch disk 300 may be formed annularly, received in a space between the first drum 120 and the second drum 220, and an outer circumferential portion thereof may be coupled to an inner circumferential surface of the first drum 120.

In this embodiment, for oil churning, the first drum 120 may include a plurality of the grooves 122 defined (e. g., engraved) in an outer circumferential surface of the first drum 120, extending in the axial direction of the first drum 120, and arranged along the circumferential direction of the first drum 120.

The second clutch disk 400 may be formed annularly facing the first clutch disk 300, received in a space between the first drum 120 and the second drum 220, and an inner circumferential portion thereof may be coupled to an outer circumferential surface of the second drum 220.

A ball ramp mechanism 500 may include a ball ramp gear capable of rotating coaxially with the first shaft 100 and the second shaft 200. The ball ramp gear is configured to engage the first clutch disk 300 and the second clutch disk 400 when rotated in a first direction (counterclockwise direction in FIG. 3, and to disengage the first clutch disk 300 from the second clutch disk 400 when rotated in a second direction (clockwise direction in FIG. 3, which is opposite to the first direction.

In other words, the ball ramp mechanism 500 may further include a case 510 arranged between the first drum 120 and the ball ramp gear 520, the case 510 being configured to support the ball ramp gear 520.

Furthermore, the case 510 may include a slot 512 configured to reciprocally receive a stopper pin 600 in an axial direction transverse to the first drum 120 and the ball ramp gear 520.

The slot 512 may have: a first opening 512a on the ball ramp gear side 520; a second opening 512b on the drum side 120, the second opening 512b having an inner diameter less than the first opening 512a; a first diameter portion 512c extending from the first opening 512a toward the second opening 512b and having the same inner diameter as the first opening 512a; a second diameter portion 512d extending from the second opening 512b toward the first opening 512a, communicating with the first diameter portion 512c and having the same inner diameter as the second opening 512b; and a step surface 512e formed by a difference in inner diameter between the first diameter portion 512c and the second diameter portion 512d.

Moreover, the ball ramp gear 520 may have a slot-facing surface with respect to the slot 512.

In this embodiment, an inclined surface 524 for moving the stopper pin 600 may be formed on the slot-facing surface.

The inclined surface 524 is configured to move the stopper pin 600 in a direction to stop the first shaft 100 when the ball ramp gear 520 rotates in the second direction. The inclined surface 524 may have a shape such that a distance to the drum decreases in a first direction from the slot-facing surface.

The stopper pin 600 may include a first end portion 610 configured to project from the first opening 512a and be supportable on the inclined surface 524, a second end portion 620 configured to project from the second opening 512b and be insertable into one of a plurality of grooves 122, and a step portion 630 projecting radially outward between the first end portion 610 and the second end portion 620.

In this case, an elastic member may be provided to pressurize the stopper pin 600 toward the inclined surface 524, wherein the elastic member may be provided as a compression coil spring 700 compressible by the step surface 512e and the step portion 630.

Hereinafter, the operation and effect of the disconnect device according to the present embodiment will be described.

Specifically, when the ball ramp gear 520 rotates in the first direction, a ball ramp plate 530 configured to press a clutch disk pack 300, 400, a combination of the first clutch disk 300 and the second clutch disk 400, may be moved toward the clutch disk pack 300, 400 by the ball ramp gear 520, as illustrated in FIG. 5, thereby pressurizing the clutch disk pack 300, 400. Accordingly, the first clutch disk 300 and the second clutch disk 400 may be engaged, thereby connecting the first shaft 100 to the second shaft 200 and allowing a vehicle to be driven in a four-wheel drive mode. In this state, a distance between the inclined surface 524 and the first opening 512a increases, and the stopper pin 600 may be moved toward the inclined surface 524 by the elastic member and withdrawn from the groove 122.

By contrast, when the ball ramp gear 520 rotates in the second direction, the ball ramp plate 530 may be moved away from the clutch disk pack 300, 400 by the ball ramp gear 520, as illustrated in FIG. 6. Accordingly, the first clutch disk 300 and the second clutch disk 400 may be disengaged from each other, thereby disconnecting the first shaft 100 from the second shaft 200 and allowing a vehicle to be driven in a two-wheel drive mode. In this case, as a distance between the inclined surface 524 and the first opening 512a decreases, the stopper pin 600 may be moved toward the first drum 120 by the inclined surface 524 and inserted into one of a plurality of grooves 122. As a result, rotation of the first drum 120 may be immediately stopped by the stopper pin 600. Accordingly, rotation of the first shaft 100, which is deactivated when switching from four-wheel drive mode to two-wheel drive mode, is immediately stopped, thereby improving fuel efficiency and power efficiency.

In this case, since the stopper pin 600 is configured to be operated by the ball ramp mechanism 500 without a separate control mechanism or drive source, responsiveness of the stopper pin 600 is improved, thereby maximizing fuel efficiency and power efficiency.

Meanwhile, since the stopper pin 600 is inserted into one of a plurality of grooves 122 and is configured to immediately stop rotation of the first shaft 100, misalignment between the stopper pin 600 and the groove 122 may cause interference or ratcheting engagement, which may damage the stopper pin 600.

In view of this, it may be desirable for the stopper pin 600, the slot 512, and the elastic member to be configured to provide an energy-storing function that stores elastic energy through axial contraction.

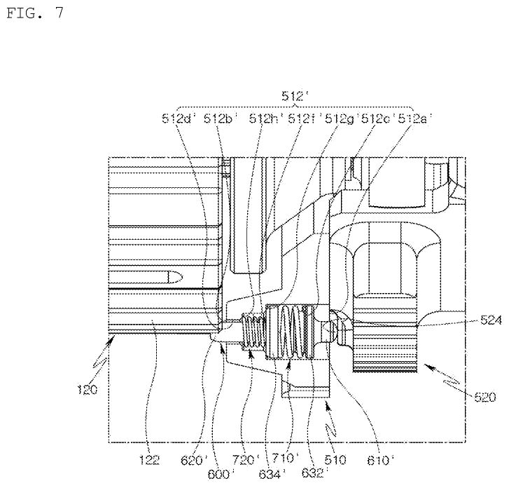

Specifically, referring to FIG. 7, the slot 512′ of a disconnect device according to another embodiment of the present disclosure may have a first opening 512a′ on a ball ramp gear; a second opening 512b′ on a first drum 120, the second opening 512b′ having a less inner diameter than the first opening 512a′; a first diameter portion 512c′ extending from the first opening 512a′ toward the second opening 512b′ and having the same inner diameter as the first opening 512a′; a second diameter portion 512d′ extending from the second opening 512b′ toward the first opening 512a′ and having the same inner diameter as the second opening 512b′; a third diameter portion 512f′ communicating with the first diameter portion 512c′ and the second diameter portion 512d′ and having an inner diameter greater than that of the second diameter portion 512d′ and less than that of the first diameter portion 512c′; a first step surface 512g′ formed by a difference in inner diameter between the first diameter portion 512c′ and the third diameter portion 512f′; and a second step surface 512h′ formed by a difference in inner diameter between the second diameter portion 512d′ and the third diameter portion 512f′.

Furthermore, the stopper pin 600′ may include a first end portion 610′ configured to project from the first opening 512a′, a second end portion 620′ formed separately from the first end portion 610′ configured to project from the second opening 512b′, a first step portion 632′ projecting radially outward from the first end portion 610′, and a second step portion 634′ projecting radially outward from the second end portion 620′.

In this embodiment, the second step portion 634′ may have a shape configured to be supportable on the first step surface 512g′.

The elastic members may be provided as a first compression coil spring 710′ compressible by the first step portion 632′ and the second step portion 634′ and a second compression coil spring 720′ compressible by the second step surface 512h′ and the second step portion 634′.

According to this configuration, when the ball ramp gear 520 rotates to implement a two-wheel drive mode, the stopper pin 600′ may be moved toward the first drum 120 and contact an end face of the first drum 120 in an out-of-phase state. In one or more embodiments, the first compression coil spring 710′ and the second compression coil spring 720′ are individually compressed, thereby storing elastic force. Accordingly, an excessive load applied between the stopper pin 600′ and the end face of the first drum 120 is prevented, thereby preventing damage. When the first drum 120 rotates slightly to achieve phase alignment, the compression force is released, allowing the stopper pin 600′ to be immediately inserted into one of a plurality of grooves 122 of the first drum 120, thereby stopping rotation of the first shaft 100.

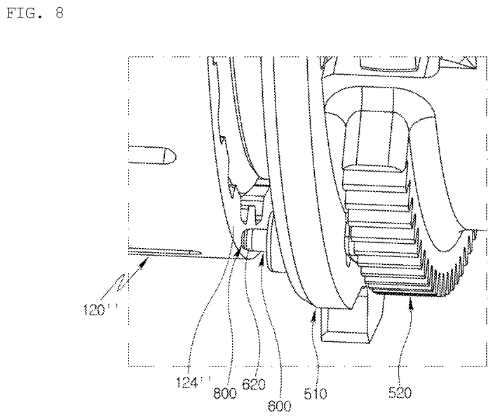

Alternatively, in order to prevent butting or ratcheting in advance, as illustrated in FIG. 8, instead of defining the grooves 122 in an outer circumferential surface of the drum 120″, an end face 124″ of the drum 120″ may be configured to extend along the circumferential direction of the drum and to face the slot. In this case, the second end portion 620 of the stopper pin 600 may be configured to be contactable with the end face 124″ of the drum 120″. More specifically, the end face 124″ of the drum 120″ may have a shape configured to press against the stopper pin 600. Additionally, a non-metallic member 800 may be disposed between the end face 124″ and the second end portion 620. Further, the non-metallic member 800 may be disposed on at least one of the second end portion 620 and the end face 124″. In particular, for cost reduction, the non-metallic member 800 may be disposed only on the second end portion 620 and not on the end face 124″. Moreover, the non-metallic member 800 may be formed of a material providing sufficient frictional force, wear resistance, heat resistance, and sound absorption. In one embodiment, the non-metallic member may be formed of a material having a coefficient of friction greater than a predetermined coefficient of friction, a heat resistance index greater than a predetermined heat resistance index, wear resistance index greater than a predetermined wear resistance index, and a noise reduction coefficient greater than a predetermined noise reduction coefficient. Especially, the non-metallic member 800 may be formed of a high-rigidity polymer material, such as at least one of polyamide-imide (PAI), polyether ether ketone (PEEK), or polyimide (PI).

What is claimed is:

1. A disconnect device comprising:
a first shaft capable of rotating;
a second shaft capable of rotating coaxially with the first shaft;
a first clutch disk coupled to the first shaft;
a second clutch disk coupled to the second shaft;
a ball ramp mechanism configured to engage and disengage the first clutch disk and the second clutch disk; and
a stopper pin configured to stop the first shaft when the first clutch disk and the second clutch disk are disengaged from each other.

2. The disconnect device of claim 1,
wherein the stopper pin is provided to be operated by the ball ramp mechanism.

3. The disconnect device of claim 2,
wherein the ball ramp mechanism includes a ball ramp gear capable of rotating coaxially with the first shaft and the second shaft, the ball ramp gear configured to engage the first clutch disk and the second clutch disk when rotated in a first direction, and to disengage the first clutch disk from the second clutch disk when rotated in a second direction opposite to the first direction, and
wherein the ball ramp gear has an inclined surface configured to move a stopper pin in a direction to stop the first shaft when rotated in the second direction.

4. The disconnect device of claim 3,
wherein the first shaft is configured to receive the first clutch disk and includes a drum coupled to an outer circumferential portion of the first clutch disk,
wherein the ball ramp mechanism further includes a case arranged between the drum and the ball ramp gear and configured to support the ball ramp gear,
wherein the case is configured to reciprocally receive the stopper pin in an axial direction transverse to the drum and the ball ramp gear,
wherein the ball ramp gear has a slot-facing surface with respect to the slot, and
wherein the inclined surface has a shape such that a distance to the drum decreases in a first direction from a slot-facing surface.

5. The disconnect device of claim 4,
wherein the drum includes a plurality of grooves defined in an outer circumferential surface of the drum, extending in the axial direction of the drum, and arranged along the circumferential direction of the drum, and
wherein the stopper pin includes a first end portion configured to be supportable on the inclined surface and a second end portion configured to be insertable into one of a plurality of grooves.

6. The disconnect device of claim 4,
wherein the drum includes an annular end face configured to extend along the circumferential direction of the drum and to face the slot, and
wherein the stopper pin includes a first end portion configured to be supportable on the inclined surface and a second end portion configured to be contactable with the end face.

7. The disconnect device of claim 6,
wherein a non-metallic member is disposed on at least one of the end face and the second end portion.

8. The disconnect device of claim 7,
the non-metallic member is disposed on the second end portion.

9. The disconnect device of claim 7,
wherein the non-metallic member is formed from a material having a coefficient of friction greater than a predetermined coefficient of friction.

10. The disconnect device of claim 4,
wherein at least an elastic member is provided to pressurize the stopper pin toward the inclined surface.

11. The disconnect device of claim 10,
wherein the slot has:
a first opening on the ball ramp gear side;
a second opening on the drum side having an inner diameter less than that of the first opening;
a first diameter portion extending from the first opening toward the second opening and having the same inner diameter as the first opening;
a second diameter portion extending from the second opening toward the first opening, communicating with the first diameter portion and having the same inner diameter as the second opening; and
a step surface formed by a difference in inner diameter between the first diameter portion and the second diameter portion,
wherein the stopper pin includes a first end portion configured to project from the first opening, a second end portion configured to project from the second opening, and a step portion projecting radially outward between the first end portion and the second end portion,
wherein at least one elastic member is provided as a compression coil spring compressible by the step surface and the step portion.

12. The disconnect device of claim 10,
wherein the slot has:
a first opening on the ball ramp gear side;
a second opening on the drum side;
the second opening having an inner diameter less than the first opening;
a first diameter portion extending from the first opening toward the second opening and having the same inner diameter as the first opening;
a second diameter portion extending from the second opening toward the first opening and having the same inner diameter as the second opening;
a third diameter portion communicating with the first diameter portion and the second diameter portion 512d′ and having an inner diameter greater than that of the second diameter portion and less than that of the first diameter portion;
a first step surface 512g′ formed by a difference in inner diameter between the first diameter portion and the third diameter portion ; and
a second step surface formed by a difference in inner diameter between the second diameter portion 512d′ and the third diameter portion,
wherein the stopper pin includes a first end portion configured to project from the first opening, a second end portion formed separately from the first end portion, a first step portion projecting radially outward from the first end portion, and a second step portion projecting radially outward from the second end portion,
wherein the second step portion is configured to be supportable on the first step surface, and
wherein at least two elastic members are provided as a first compression coil spring compressible by the first step portion and the second step portion, and a second compression coil spring compressible by the second step surface and the second step portion.
